(19) United States
(12) Patent Application Publication
(10) Pub. No.: US 2026/0292119 A1
(43) Pub. Date: Sep. 24, 2026

(54) REPROJECTION IN FIELD SEQUENTIAL DISPLAYS

(71) Applicant: QUALCOMM Incorporated, San Diego, CA (US)

(72) Inventors: Vinay MELKOTE KRISHNAPRASAD, Bangalore (IN); Dam BACKER, San Diego, CA (US); Simon Peter William BOOTH, San Diego, CA (US)

(21) Appl. No.: 19/476,119

(22) PCT Filed: Feb. 14, 2024
(86) PCT No.: PCT/US2024/015865

§ 371 Date: Oct. 16, 2025

(30) Foreign Application Priority Data
May 10, 2023 (IN) 202321032952

(51) Int. Cl. H04N 13/327; G09G 5/37; H04N 13/00; H04N 13/324; H04N 13/344

(52) U.S. Cl. CPC H04N 13/327; G09G 5/37; H04N 13/324; H04N 13/344; G09G 2360/10; H04N 2013/0085

(57) ABSTRACT

This disclosure provides systems, devices, apparatus, and methods, including computer programs encoded on storage media, for reprojecting a field. One or more processing cores may apply a single grid inversion to data representing a set of field images comprising a first field image, a second field image, and a third field image. The processing core(s) may determine a mapping comprising a set of motion vectors, wherein the set of motion vectors indicate a point-to-point mapping from a display space to a rendered eye buffer space. The processing core(s) may apply pixel shading to the first field image based on the set of motion vectors, to the second field image based on the set of motion vectors and second pose data associated with the second field image, and to the third field image based on the set of motion vectors and third pose data associated with the third field image.

### TECHNICAL CROSS REFERENCE TO RELATED APPLICATIONS

This application claims the benefit of Indian Provisional Patent Application Number 202321032952, entitled “REPROJECTION IN FIELD SEQUENTIAL DISPLAYS” and filed on May 10, 2023, which is expressly incorporated by reference herein in its entirety.

### TECHNICAL FIELD

The present disclosure relates generally to processing systems and, more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or a display processing unit (DPU) may be configured to perform the processes of display processing. However, with the advent of wireless communication and smaller, handheld devices, there has developed an increased need for improved display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a display processing unit (DPU), a graphics processing unit (GPU), a central processing unit (CPU), or any apparatus that may perform display processing. The apparatus includes a memory and a processor coupled to the memory, and based on information stored in the memory, the processor is configured to: determine a mapping including a set of motion vectors based on a single grid inversion to data representing a set of field images including a first field image, a second field image, and a third field image, where the single grid inversion is based on first pose data associated with the first field image; and apply pixel shading to the first field image based on the set of motion vectors, to the second field image based on the set of motion vectors and second pose data associated with the second field image, and to the third field image based on the set of motion vectors and third pose data associated with the third field image. Although the following description may be focused on display processing, the concepts described herein may be applicable to other similar processing techniques.

The details of one or more examples of the disclosure are set forth in the accompanying drawings and the description below. Other features, objects, and advantages of the disclosure will be apparent from the description and drawings, and from the claims.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 depicts a diagram illustrating example techniques for displaying an image in accordance with one or more techniques of this disclosure.

FIG. 5 is a diagram illustrating example techniques for reprojecting a field in accordance with one or more techniques of this disclosure.

FIG. 6 is a diagram illustrating example techniques for reprojecting a field at a client in accordance with one or more techniques of this disclosure.

FIG. 7 depicts a diagram illustrating example techniques for reprojecting a field in accordance with one or more techniques of this disclosure.

FIG. 8 depicts a diagram illustrating example techniques for reprojecting a field in accordance with one or more techniques of this disclosure.

FIG. 9 is a call flow diagram illustrating example communications between a first display processor component and a second display component in accordance with one or more techniques of this disclosure.

FIG. 10 is a flowchart of an example method of display processing in accordance with one or more techniques of this disclosure.

FIG. 11 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

In augmented reality (AR), anchored virtual content may stay in place relative to real-world objects as the user's head moves. Registration of virtual content to the real world may be influenced by at least two factors: latency between when content was rendered to when it is displayed (e.g., motion-2-render-2-photon (m2r2p) latency); and render rate relative to display rate (e.g., lower render rate can result in judder and registration error).

Asynchronous time-warp may reproject the rendered content for the user's head pose just prior to display via a homography. This may help with AR content registration, but may be deficient in that it accounts for user-orientation change without accounting for other factors. Modifications to a warp, such as Asynchronous Planar Reprojection (APR) may address some shortcomings (e.g., such as accounting for head position change using depth metadata for the content). However, different virtual objects in AR may be registered to different points in the world, and applying a single homography on the entire frame may not be sufficient to fix registration error for all virtual objects.

AR glasses may be thermally constrained. Thus, keeping power consumption minimal on the AR glasses may be beneficial. Even a savings of 10mW per feature may be valuable. Much of the power burn for reprojection may be in the pixel shader, but for a grid inversion step on the GPU may also utilize a significant amount of power. Aspects of the present disclosure may reduce the grid inversion power by exercising the grid inversion step once per a set of fields (e.g., once for each red-green-blue (RGB) triplet). For instance, grid inversion may be performed once per set of fields to determine a single coarse mapping per set (rather than performing the grid inversion for each field in a sequential manner). For each field, pixel shading may be applied based on the single coarse mapping. As used herein, a “field” (or “field image”) may correspond to primary color information corresponding to a particular color component of an image to be displayed. For instance, in a field sequential display, a first field (e.g., a red field including the red components of an image), a second field (e.g., a green field including the green components of the image), and a third field (e.g., a blue field including the blue components of the image) may be successively provided to a display processing unit for display. As also used herein, a “grid inversion” may refer to a technique for determining a location to reproject an image based on a user's movement (e.g., head movement) and a distance between an object represented by the image and the user. The result of the grid inversion may be a point-to-point mapping of the image from display space to rendered eye-buffer space. As further used herein, “pixel shading” may refer to providing the eye buffer to the display per-field in a sequential manner based on the mapping of the grid inversion.

Various technologies pertaining to reprojection in field sequential displays are described herein. In an example, an apparatus determines a mapping including a set of motion vectors based on a single grid inversion to data representing a set of field images comprising a first field image, a second field image, and a third field image, where the single grid inversion is based on first pose data associated with the first field image. The apparatus applies pixel shading to the first field image based on the set of motion vectors, to the second field image based on the set of motion vectors and second pose data associated with the second field image, and to the third field image based on the set of motion vectors and third pose data associated with the third field image. Vis-à-vis determining the mapping including the set of motion vectors based on a single grid inversion (rather than performing the grid inversion for each field in a sequential manner), the apparatus may conserve computing resources and/or power.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

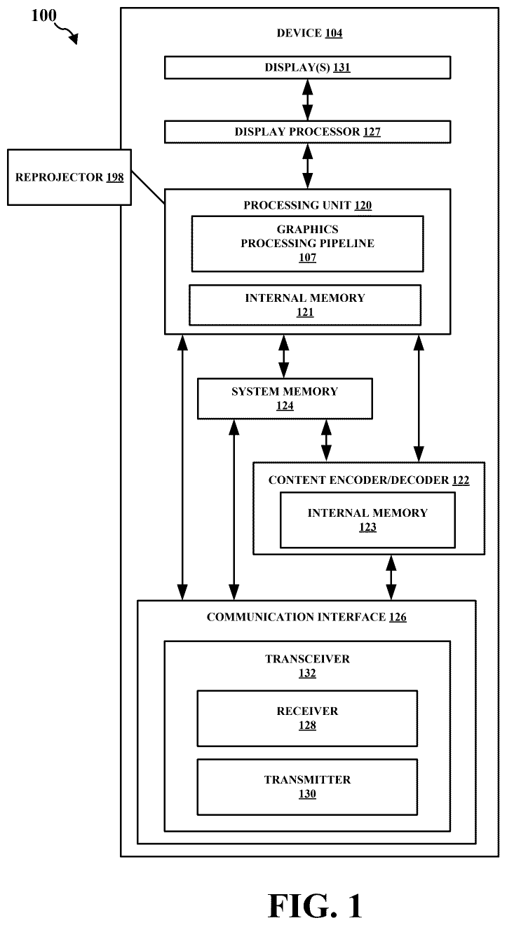

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a reprojector 198 configured to determine a mapping including a set of motion vectors based on a single grid inversion to data representing a set of field images including a first field image, a second field image, and a third field image, where the single grid inversion is based on first pose data associated with the first field image; and apply pixel shading to the first field image based on the set of motion vectors, to the second field image based on the set of motion vectors and second pose data associated with the second field image, and to the third field image based on the set of motion vectors and third pose data associated with the third field image. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

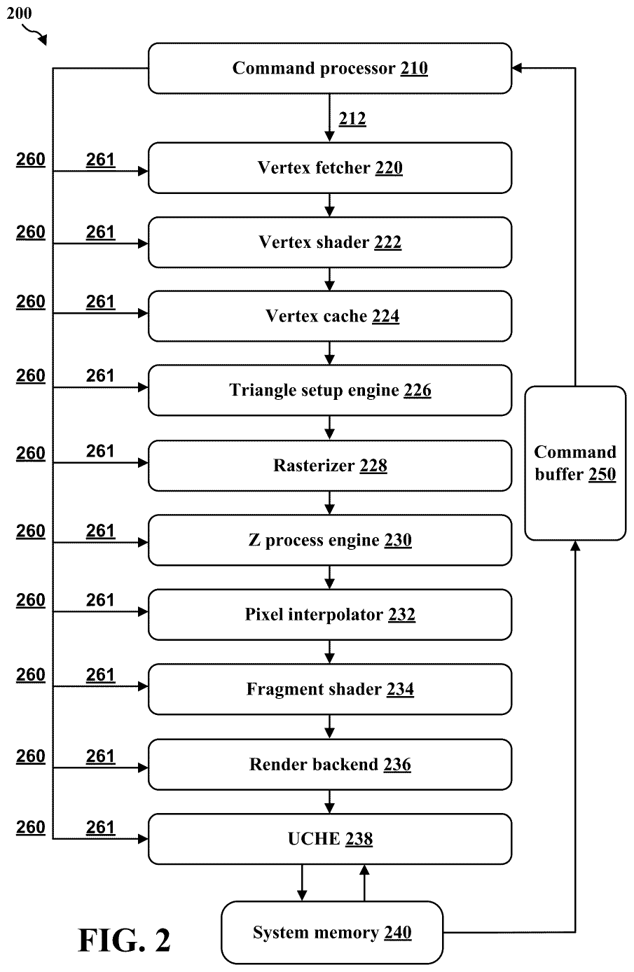

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

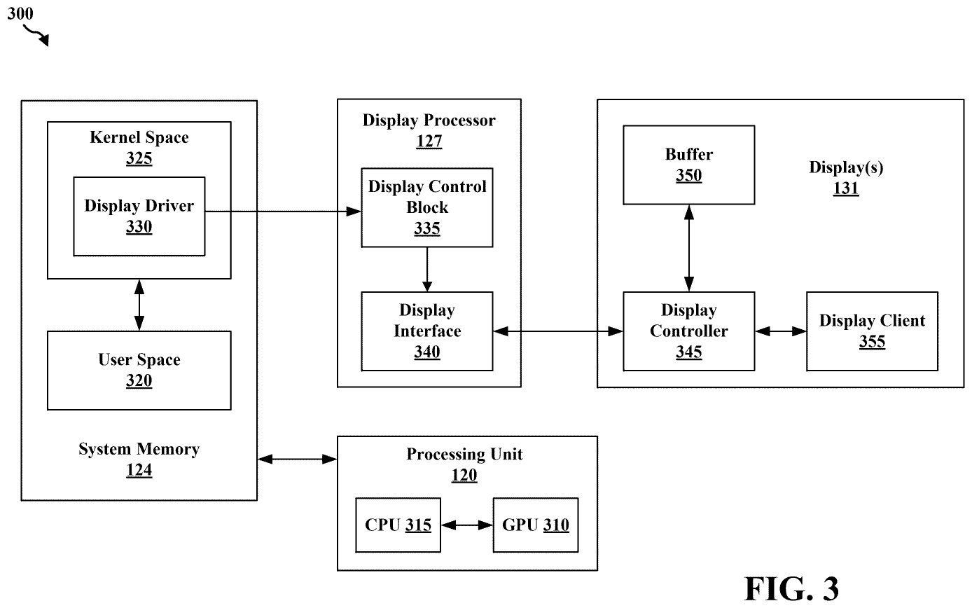

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

A user may wear a display device in order to experienced extended reality (XR) content. XR may refer to a technology that blends aspects of a digital experience and the real world. Content associated with XR may be referred to as XR content. XR may include augmented reality (AR), mixed reality (MR), and/or virtual reality (VR). A device that is capable of presenting XR content may be referred to as an XR device. In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. Content associated with AR may be referred to as AR content. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. Content associated with MR may be referred to as MR content. In VR, a user may experience a fully-immersive digital environment in which the real-world is blocked out. VR content may be experienced through a HMD. Content associated with VR may be referred to as VR content.

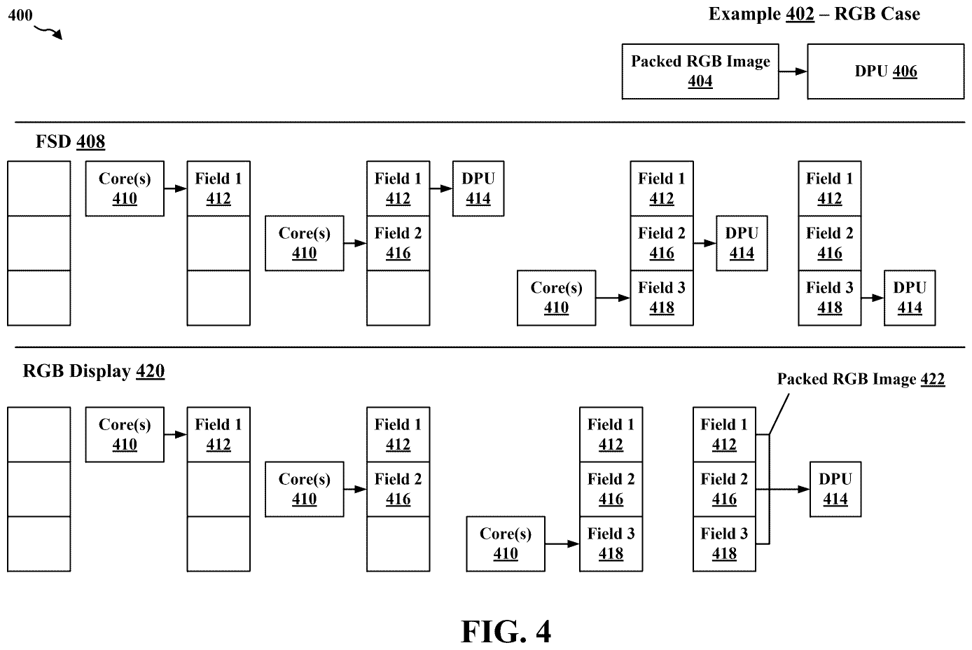

FIG. 4 depicts a diagram 400 illustrating example techniques for displaying an image in accordance with one or more techniques of this disclosure. In augmented reality (AR), an experience of a user may depend on anchored visual content staying in place relative to real world objects as a head of a user moves while wearing an AR device. Registration of virtual content to the real world may be influenced by at least two factors. First, the registration may be influenced by a latency between a time at which virtual content is rendered and a time at which the virtual content is displayed. This may be referred to as a motion-2-render-2-photon (mr2rp) latency. Second, the registration may be influenced by a render rate relative to a display rate. A lower render rate may result in judder and registration error. Judder may refer to motion on a screen having uneven pacing. Registration error may refer to an error in transforming different sets of data (e.g., image data) into one coordinate system.

An asynchronous time warp may reproject rendered content (i.e., rendered virtual content) for a head pose of a user wearing an XR device immediately prior to a display of the virtual content via a homography. A homography may refer to a projective transformation between two planes or, alternatively, a mapping between two planar projections of an image. Stated differently, a homography may refer to an image transformation that describes a relative motion between two images when an observer (e.g., a user) moves. A time warp may refer to a technique that warps a rendered image before sending the image to a display in order to correct for head motion that occurred after the image was rendered in order to reduce perceived latency. An asynchronous time warp may refer to a technique that generates intermediate frames in situations in which an application is not able to maintain a frame rate in order to reduce judder. In one aspect, an asynchronous time warp may refer to performing a time warp on a thread in parallel with rendering. For instance, before every Vsync, a thread associated with an asynchronous time warp may generate a new timewarped frame from a latest frame completed by a rendering thread. An asynchronous time warp may help to reduce registration errors (e.g., AR content registration errors); however, an asynchronous time warp may account for a user orientation change without taking into account other factors (e.g., a head position change). An asynchronous planar reprojection (APR) may take into account a head position change of a user using depth metadata from content (e.g., an image). However, different virtual objects in AR may be registered to different points in the real world. Applying a single homography on an entire frame may not be able to fix registration errors for each of the different points.

A field sequential display (FSD) may refer to a display that updates color-by-color by each color being separately passed to a display processing unit (DPU). In some FSDs, a processing core (which may also be referred to as “a core”) may take in an eye buffer and produce a warped field to be displayed. With more particularity, in an FSD, a processing core may serially generate color fields. After a color field is generated, the color field may be passed to a DPU while the processing core begins to generate a next color field. In contrast, a red green blue (RGB) display may refer to a display in which a processing core generates all color fields of an image (i.e., a packed RGB image) before all of the color fields are transferred to a DPU. In an example 402 pertaining to an RGB case, a content pipeline may generate a packed RGB image 404 and the content pipeline may transfer the packed RGB image 404 to a DPU 406 for display. In an example, the DPU 406 may be or include the display processor 127.

The diagram 400 depicts example operation of an FSD 408. In an example, the FSD 408 may be or include the display(s) 131 of the device 104. Core(s) 410 of the FSD 408 may generate a first field 412 prior to the first field 412 being utilized by a DPU 414. In an example, the core(s) 410 and the DPU 414 may be included in the device 104. The core(s) 410 may alternatively be referred to as processing cores. A field (e.g., the first field 412) may alternatively be referred to as a color field, a field image, or a color field image. In an example, the first field 412 may be a red field (i.e., a red color field). The first field 412 may then be transferred to the DPU 414, whereupon the DPU 414 may begin to transfer the first field 412 (i.e., a surface associated with the first field 412) to a display (e.g., the display(s) 131). Subsequent to the generation of the first field 412, the core(s) 410 may generate a second field 416. In an example, the second field 416 may be a green field (i.e., a green color field). The second field 416 may then be transferred to the DPU 414, whereupon the DPU 414 may begin to transfer the second field 416 (a surface associated with the second field 416) to the display. In one aspect, the core(s) 410 may generate the second field 416 concurrently with the first field 412 being transferred to the DPU 414 or subsequent to the first field 412 being transferred to the DPU 414. In another aspect, the core(s) 410 may generate the second field 416 concurrently with the first field 412 being transferred to the display or subsequent to the first field 412 being transferred to the display. Subsequent to the generation of the second field 416, the core(s) 410 may generate a third field 418. In an example, the third field 418 may be a blue field (i.e., a blue color field). In one aspect, the core(s) 410 may generate the third field 418 concurrently with the second field 416 being transferred to the DPU 414 or subsequent to the second field 416 being transferred to the DPU 414. In another aspect, the core(s) 410 may generate the third field 418 concurrently with the second field 416 being transferred to the display or subsequent to the second field 416 being transferred to the display. The third field 418 may then be transferred to the DPU 414, whereupon the DPU 414 may begin to transfer the third field 418 (a surface associated with the third field 418) to the display.

The diagram 400 depicts example operation of an RGB display 420. In an example, the RGB display 420 may be or include the display(s) 131 of the device 104. The core(s) 410 may generate the first field 412. The core(s) 410 may generate the second field 416. The core(s) may generate the third field 418. The first field 412, the second field 416, and the third field 418 may be collectively referred to as a packed RGB image 422. The packed RGB image 422 may then be transferred to the DPU 414, whereupon the DPU 414 may transfer the packed RGB image 422 to a display. In an example, the DPU 414 may read the first field 412, the second field 416, and the third field 418 from the packed RGB image 422 at the same time.

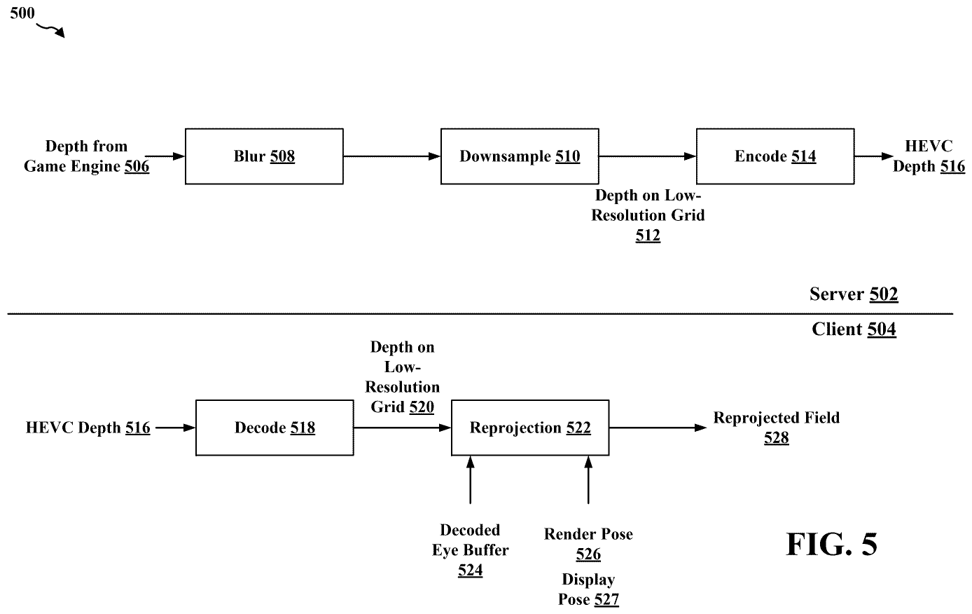

FIG. 5 is a diagram 500 illustrating example techniques for reprojecting a field in accordance with one or more techniques of this disclosure. Depth cues may significantly reduce the perception of judder. An APR may reduce judder due to the APR utilizing depth (i.e., depth information) as part of the single plane model. A depth-buffer based late stage reprojection (LSR) may utilize more fine-grained depth rendered by a game engine to accurately reproject each part of a scene. In one aspect, a device (e.g., an XR device) may include an FSD and LSR may run separately for each field (i.e., each floor field) due to a display pose being slightly different for each field.

In the diagram 500, a server 502 and a client 504 may be configured in a split rendering configuration (i.e., a split XR rendering configuration). Split rendering may refer to a paradigm in which certain rendering tasks are performed by the server 502 and other rendering tasks are performed by the client 504. In one example, the server 502 may be the device 104. In another example, the client 504 may be the device 104. In an example, the client 504 may XR glasses worn on/over/around a head of a user. In an example, the server 502 may include first processing capabilities and the client 504 may include second processing capabilities, where the first processing capabilities may be greater than the second processing capabilities. For instance, the server 502 may include faster processor(s) compared to processor(s) of the client 504. In an example, the server 502 may have a first battery capacity and the client 504 may have a second battery capacity, where the first battery capacity may be greater than the second battery capacity. In an example, the client 504 may have a smaller mass and/or smaller dimensions compared to a mass and/or dimensions of the server 502.

The server 502 may obtain a depth from a game engine 506. A game engine may refer to a software frame associated with video games that includes relevant libraries and support programs. The server 502 may perform a blur 508 on the depth from the game engine 506. The server may perform a downsample 510 on the (blurred) depth from the game engine 506. The downsample 510 may produce a depth on a low-resolution grid 512. The server 502 may perform an encode 514 on the depth on the low-resolution grid 512. The encode 514 may produce a high-efficiency video coding (HEVC) depth 516 (i.e., depth as HEVC). HEVC may refer to a video compression standard. Alternatively, the encode may produce an advanced video coding (AVC) depth, a versatile video coding (VVC) depth, an Alliance for Open Media (AOMedia) Video depth, or a VP9 depth. The server 502 may transmit the HEVC depth 516 to the client 504 via a wireless connection or a wired connection.

The client 504 may receive the HEVC depth 516 from the server 502. The client may perform a decode 518 (i.e., an HEVC decode) on the HEVC depth 516. Alternatively, the decode may be an AVC decode, a VVC decode, an AOMedia video depth decode, or a VP9 decode. The decode 518 may produce a depth on a low-resolution grid 520. The depth on the low-resolution grid 520 may be similar or identical to the depth on the low-resolution grid 512. The client 504 may perform a reprojection 522 based on the depth on the low-resolution grid 520, a decoded eye buffer 524, a render pose 526, and a display pose 527. In an example, the reprojection 522 may be referred to as a late stage reprojection (LSR). The render pose 526 may be generated at a time of rendering (e.g., at the server 502). The display pose 527 may be generated at the client 504 prior to displaying an image associated with the decoded eye buffer 524. The reprojection 522 may produce a reprojected field 528 (e.g., a reprojected red field, a reprojected green field, or a reprojected blue field). Aspects pertaining to the reprojection 522 will be discussed in greater detail below.

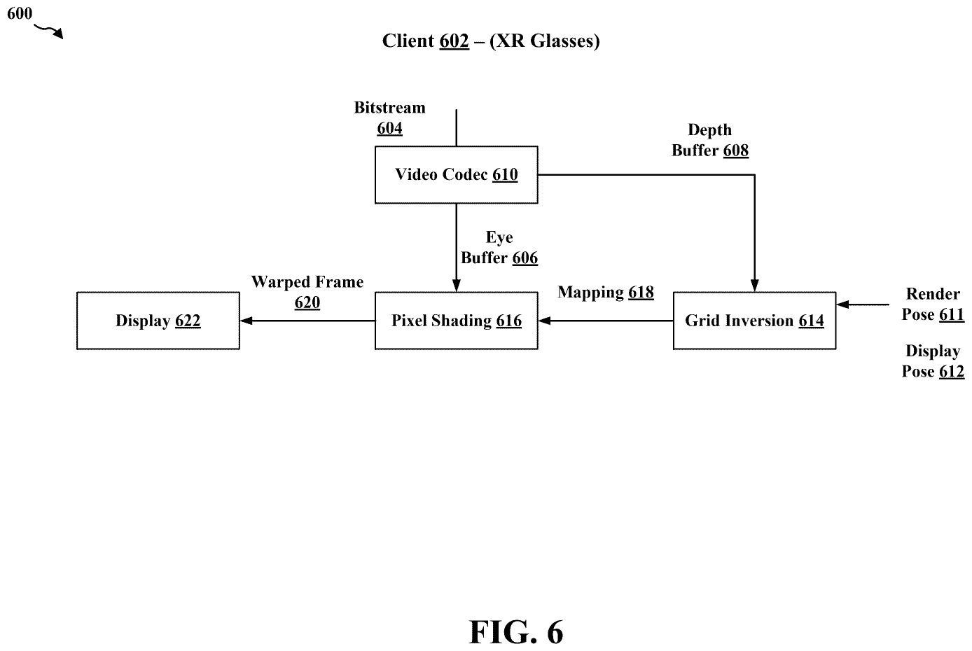

FIG. 6 is a diagram 600 illustrating example techniques for reprojecting a field at a client 602 in accordance with one or more techniques of this disclosure. In an example, the client 602 may be or include the client 504. In an example, the client 602 may be the device 104. In an example, the client 602 may be XR glasses worn on/over/around a head of a user.

The client 602 may obtain a bitstream 604. The bitstream 604 may be encoded. In an example, the client 602 may obtain the bitstream from a server (e.g., the server 502) via a wired connection or a wireless connection. The bitstream 604 may include encoded data corresponding an eye buffer 606 and a depth buffer 608. The eye buffer 606 may correspond to a planar RGB image and the depth buffer 608 may correspond to depth associated with the planar RGB image. In an example, the depth buffer 608 maybe indicative of a distance between an object represented by a set of field images and the user. In an example, the depth buffer 608 may be a downsampled depth buffer. The client 602 may decode the bitstream 604 via a video codec 610. In an example, the video codec 610 may be an HEVC. Decoding the bitstream 604 via the video codec 610 may produce the eye buffer 606 and the depth buffer 608 at the client 602. The client 602 may also obtain a render pose 611 and a display pose 612. The render pose 611 may be a pose of a head of the user at a time of rendering of the eye buffer 606 and the depth buffer 608 (e.g., at a server). The display pose 612 may be a pose of the head of the user at a time of display, where the time of display occurs subsequent to the time of rendering.

Reprojection (e.g., LSR) may include two main steps: a grid inversion 614 and pixel shading 616. In the grid inversion 614, the client 602 may determine a set of motion vectors based on the depth buffer 608 (i.e., a downsampled depth buffer), the render pose 611, and the display pose 612. The set of motion vectors may describe or indicate a mapping 618 (i.e., a point-to-point mapping) from a display space to a rendered eye buffer space. In one aspect, the set of motion vectors may include a first subset of motion vectors corresponding to a red color field of a frame, a second subset of motion vectors corresponding to a green color field of the frame, and a third subset of motion vectors corresponding to blue color field of the frame. In another aspect, the set of motion vectors may be for a particular color field (e.g., a red color field, a green color field, or a blue color field). A GPU of the client 602 may perform the grid inversion 614. The grid inversion 614 may be performed sequentially for each field (i.e., each color field) associated with the depth buffer 608.

In the pixel shading 616, the client 602 may generate a warped frame 620 based on the eye buffer 606 and the mapping 618. The warped frame 620 may be referred to as an output display buffer. The pixel shading 616 may be performed by a processing core (e.g., the core(s) 410). For instance, the pixel shading 616 may include the processing core executing a pixel shader. The pixel shading 616 may generate (i.e., produce) the warped frame 620 sequentially per field. The warped frame 620 may be presented on a display 622 of the client 602. In an example, the display may be or include the display(s) 131.

AR glasses may be thermally constrained. Thus, keeping power consumption minimal on the glass may be beneficial. Even a savings of 10mW per feature may be valuable. Much of the power burn for reprojection may be in a pixel shader (i.e., the pixel shading 616), but for a grid inversion step (e.g., the grid inversion 614) on the GPU may also utilize a significant amount of power. Aspects of the present disclosure may reduce power consumed by a grid inversion by exercising the grid inversion step once per a set of fields (e.g., once for each RGB triplet).

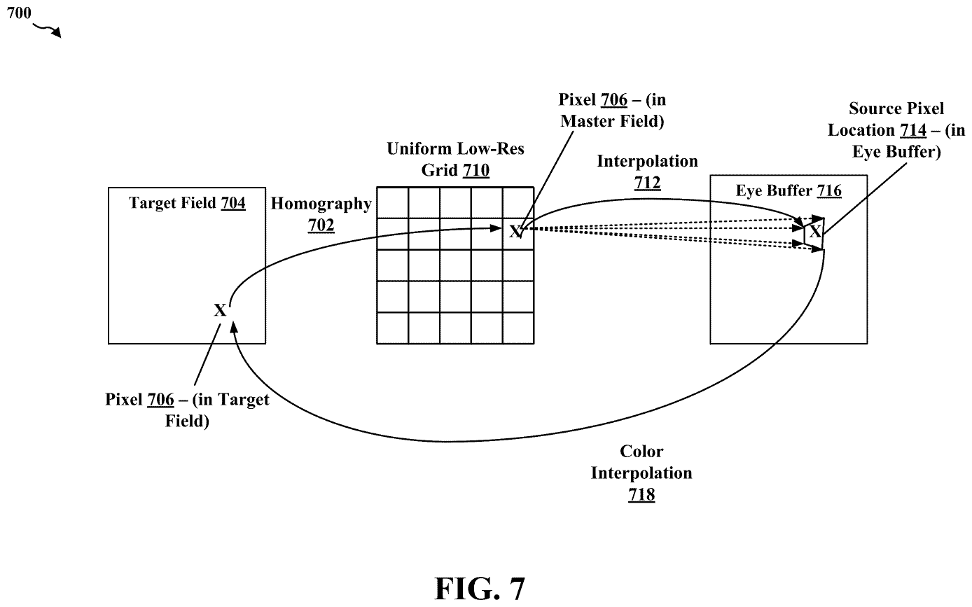

FIG. 7 depicts a diagram 700 illustrating techniques for reprojecting a field in accordance with one or more techniques of this disclosure. In one aspect described herein, a complete grid inversion may be performed once per set of fields (e.g., once for each RGB triplet) in order to determine one coarse mapping per set of fields. In an example, a depth buffer based pass on a GPU may be performed once for a “master field” in a set of fields. In an example, the “master field” may be a red field in an RGB triplet. For remaining fields in the set of fields (e.g., the green field and the blue field), a processing core may perform a homography based correction to a set of motion vectors as part of pixel shading (e.g., the pixel shading 616). A processing core may be configured to utilize two types of mappings for warping: (1) a motion vector based mapping that maps motion vectors onto a fixed output grid and (2) a homography based mapping (e.g., an isomorphism of projected spaces, induced by an isomorphism of the vector spaces from which the projective spaces derive).

In the diagram 700, a homography 702 based on a pose difference between a target field 704 (e.g., a green field or a blue field) and a master field (e.g., a red field) may map a location of a pixel 706 in the target field 704 to a location of the pixel 706 in the master field. The master field may be associated with a uniform low resolution grid 710 in a display space on which motion vectors are defined based on a grid inversion (e.g., the grid inversion 614). An interpolation 712 may be performed on the motion vectors to find a source pixel location 714 in an eye buffer 716. A color interpolation 718 (i.e., an interpolation of colors) may be performed in a neighborhood (i.e., in adjacent pixels) of the source pixel location 714 in order to provide a pixel color for the pixel 706 in the target field 704.

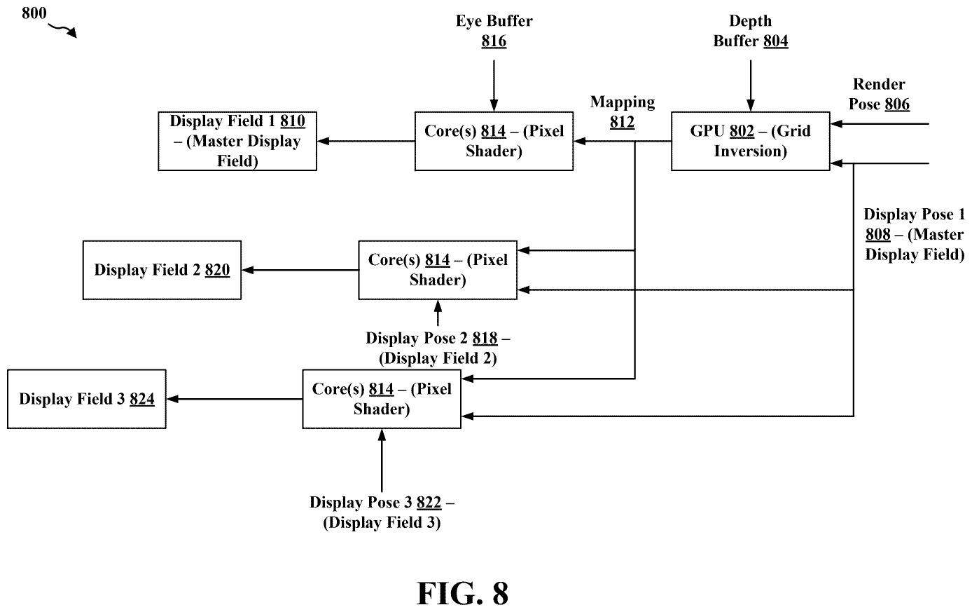

FIG. 8 depicts a diagram 800 illustrating techniques for reprojecting a field in accordance with one or more techniques of this disclosure. A GPU 802 of a client (e.g., the client 602) may obtain a depth buffer 804, a render pose 806, and a first display pose 808. In an example, the depth buffer 804 may be the depth buffer 608 and the render pose 806 may be the render pose 611. The first display pose 808 may correspond to a first display field 810. The first display field 810 may be referred to as a master display field. In an example, the first display field 810 may be a red field (i.e., a red color field). The GPU 802 may perform a grid inversion (e.g., the grid inversion 614) based on the depth buffer 804, the render pose 806, and the first display pose 808. The grid inversion may generate a mapping 812 (e.g., the mapping 618). Core(s) 814 (e.g., the core(s) 410) of the client may obtain the mapping 812 and an eye buffer 816. In an example, the eye buffer 816 may be the eye buffer 606. The core(s) 814 may perform pixel shading (e.g., the pixel shading 616) based on the eye buffer 816 and the mapping 812 in order to generate the first display field 810 (e.g., a red color field).

The core(s) 814 may obtain a second display pose 818 corresponding to a second display field 820. In an example, the second display field 820 may be a green field (i.e., a green color field). The core(s) 814 may also obtain the first display pose 808. The core(s) 814 may perform pixel shading (e.g., the pixel shading 616) based on the first display pose 808, the second display pose 818, the mapping 812, and a homography (e.g., the homography 702) to generate the second display field 820 (e.g., a green color field).

The core(s) 814 may obtain a third display pose 822 corresponding to a third display field 824. In an example, the third display field 824 may be a blue field (i.e., a blue color field). The core(s) 814 may also obtain the first display pose 808. The core(s) 814 may perform pixel shading (e.g., the pixel shading 616) based on the first display pose 808, the third display pose 822, the mapping 812, and a homography (e.g., the homography 702) to generate the third display field 824 (e.g., a blue color field). The first display field 810, the second display field 820, and the third display field 824 may be presented on a display (e.g., the display(s) 131).

Although the description of reprojection (e.g., LSR) above focuses on performing a reprojection using a depth buffer (e.g., the depth buffer 804), other possibilities are contemplated. In one aspect, reprojection may be driven by planar metadata instead of a depth buffer. The planar metadata may include plane parameters of a plane (e.g., a surface) to be rendered. The plane parameters may include, but are not limited to, pose, dimensions, and/or boundary points. In another aspect, reprojection may be driven by motion vectors between consecutive eye buffer frames (e.g., asynchronous space warp) instead of a depth buffer. Asynchronous space warp may refer to a technique that tracks animation and movement within a scene to generate a smooth user experience. For instance, asynchronous space warp may track character movement, camera movement, touch controller movement, and/or positional movement of a user in order to generate the smooth user experience.

As indicated above, an FSD may have a temporal display sequence of “. . . RGB, RGB, RGB . . . ” in which an R field is a master field and in which a G field and a B field are slave fields. As described above, a grid of motion vectors may be computed for the R field and grids of motion vectors for the G field and the B field may be computed via modifying the grid of motion vectors for the R field with a homography. However, other possibilities are contemplated. In one aspect, a grid of motion vectors may be computed for the B field. Grids of motion vectors may be computed for the R field and the G field via a homography, where the homography may be based on a pose difference between the B field and the R field or a pose difference between the B field and the G field. This may help to reduce approximation errors involved in computing motion vectors for slave fields. In another aspect, a grid of motion vectors may be computed for the G field. Grids of motion vectors may be computed for the R field and the B field via a homography, where the homography may be based on a pose difference between the B field and the R field or a pose difference between the B field and the G field.

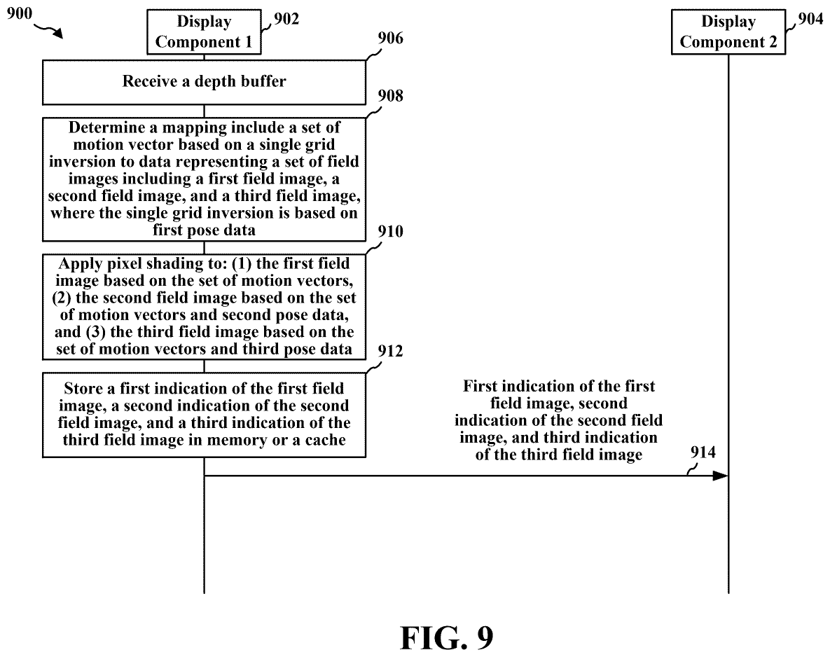

FIG. 9 is a call flow diagram 900 illustrating example communications between a first display component 902 and a second display component 904 in accordance with one or more techniques of this disclosure. In an example, the first display component 902 and/or the second display component 904 may be included in the device 104. In an example, the first display component 902 may be or include software executed by a CPU and the second display component 904 may be a display processor (e.g., the display processor 127). In an example, the first display component 902 and/or the second display component 904 may be or include a processing core. In an example first display component 902 and/or the second display component 904 may be or include a graphics processor (e.g., a GPU).

At 908, the first display component 902 may determine a mapping including a set of motion vectors based on a single grid inversion to data representing a set of field images including a first field image, a second field image, and a third field image, where the single grid inversion is based on first pose data associated with the first field image. At 910, the first display component 902 may apply pixel shading to the first field image based on the set of motion vectors, to the second field image based on the set of motion vectors and second pose data associated with the second field image, and to the third field image based on the set of motion vectors and third pose data associated with the third field image.

At 906, the first display component 902 may receive a depth buffer, where the depth buffer includes depth information indicative of a distance associated with an object represented by the set of field images, and wherein the depth buffer is associated with the data representing the set of field images. At 912, the first display component 902 may store a first indication of the first field image, a second indication of the second field image, and a third indication of the third field image in a first memory or a cache, where the first indication of the first field image is based on the application of the pixel shading to the first field image, the second indication of the second field image is based on the application of the pixel shading to the second field image, and the third indication of the third field image is based on the application of the pixel shading to the third field image. At 914, the first display component 902 may transmit a first indication of the first field image, a second indication of the second field image, and a third indication of the third field image to a display processor (e.g., the second display component 904) for display of the first field image, the second field image, and the third field image, where the first indication of the first field image is based on the application of the pixel shading to the first field image, the second indication of the second field image is based on the application of the pixel shading to the second field image, and the third indication of the third field image is based on the application of the pixel shading to the third field image.

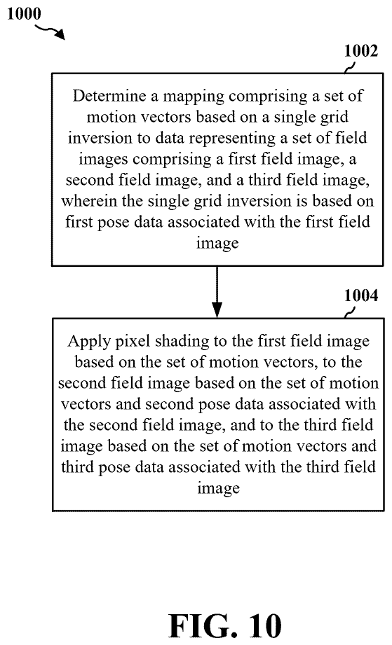

FIG. 10 is a flowchart 1000 of an example method of display processing in accordance with one or more techniques of this disclosure. The method may be performed by an apparatus, such as an apparatus for display processing, a CPU, software executed by a CPU, a graphics processor (e.g., a GPU), a DPU (or other display processor), the device 104, a wireless communication device, a head-mounted display, and the like, as used in connection with the examples of FIGS. 1-9. In an example, the method may be performed by the reprojector 198.

At 1002, the apparatus determines a mapping including a set of motion vectors based on a single grid inversion to data representing a set of field images including a first field image, a second field image, and a third field image, where the single grid inversion is based on first pose data associated with the first field image. For example, FIG. 9 at 908 shows that the first display component 902 may determine a mapping including a set of motion vectors based on a single grid inversion to data representing a set of field images including a first field image, a second field image, and a third field image, where the single grid inversion is based on first pose data associated with the first field image. In an example, the mapping may be or include the mapping 812 or the mapping 618. In an example, the single grid inversion may correspond to the grid inversion in FIG. 8. In an example, the first field image, the second field image, and the third field image may correspond to the first field 412, the second field 416, and the third field 418, respectively. In an example, the first field image, the second field image, and the third field image may correspond to the first display field 810, the second display field 820, and the third display field 824, respectively. In an example, the first pose data may be or include the first display pose 808. In an example, 1002 may be performed by the reprojector 198.

At 1004, the apparatus applies pixel shading to the first field image based on the set of motion vectors, to the second field image based on the set of motion vectors and second pose data associated with the second field image, and to the third field image based on the set of motion vectors and third pose data associated with the third field image. For example, FIG. 9 at 910 shows that the first display component 902 may apply pixel shading to the first field image based on the set of motion vectors, to the second field image based on the set of motion vectors and second pose data associated with the second field image, and to the third field image based on the set of motion vectors and third pose data associated with the third field image. In an example, the pixel shading may be the pixel shading 616. In an example, the pixel shading may be the pixel shading performed by the core(s) 814 in FIG. 8. In an example, the second pose data may be or include the second display pose 818 and the third pose data may be or include the third display pose 822. In an example, 1004 may be performed by the reprojector 198.

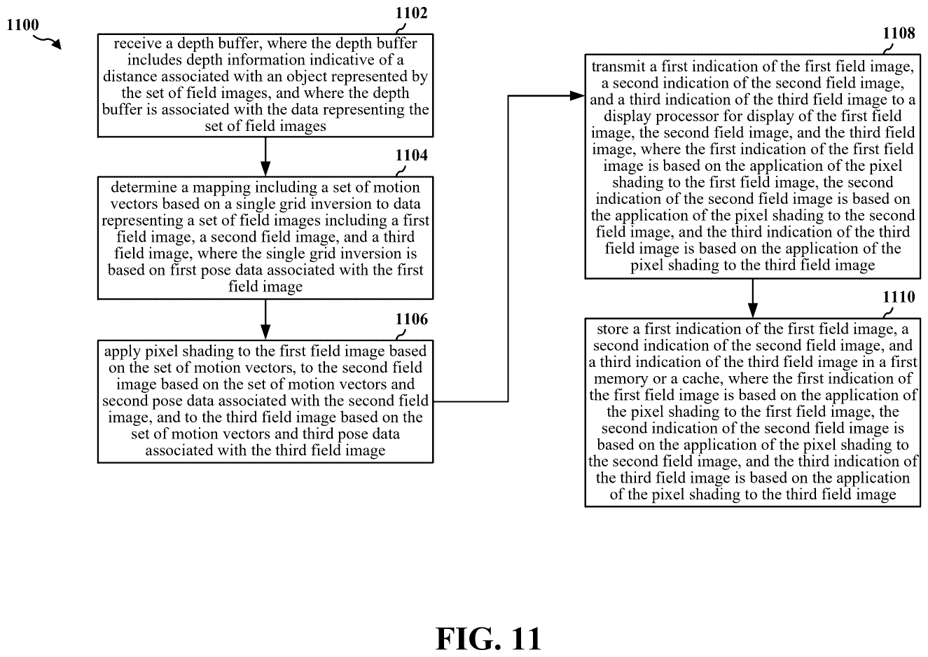

FIG. 11 is a flowchart 1100 of an example method of display processing in accordance with one or more techniques of this disclosure. The method may be performed by an apparatus, such as an apparatus for display processing, a CPU, software executed by a CPU, a graphics processor (e.g., a GPU), a DPU (or other display processor), the device 104, a wireless communication device, a head-mounted display, and the like, as used in connection with the examples of FIGS. 1-9. In an example, the method (including the various aspects detailed below) may be performed by the reprojector 198.

At 1104, the apparatus determines a mapping including a set of motion vectors based on a single grid inversion to data representing a set of field images including a first field image, a second field image, and a third field image, where the single grid inversion is based on first pose data associated with the first field image. For example, FIG. 9 at 908 shows that the first display component 902 may determine a mapping including a set of motion vectors based on a single grid inversion to data representing a set of field images including a first field image, a second field image, and a third field image, where the single grid inversion is based on first pose data associated with the first field image. In an example, the mapping may be or include the mapping 812 or the mapping 618. In an example, the single grid inversion may correspond to the grid inversion in FIG. 8. In an example, the first field image, the second field image, and the third field image may correspond to the first field 412, the second field 416, and the third field 418, respectively. In an example, the first field image, the second field image, and the third field image may correspond to the first display field 810, the second display field 820, and the third display field 824, respectively. In an example, the first pose data may be or include the first display pose 808. In an example, 1104 may be performed by the reprojector 198.

At 1106, the apparatus applies pixel shading to the first field image based on the set of motion vectors, to the second field image based on the set of motion vectors and second pose data associated with the second field image, and to the third field image based on the set of motion vectors and third pose data associated with the third field image. For example, FIG. 9 at 910 shows that the first display component 902 may apply pixel shading to the first field image based on the set of motion vectors, to the second field image based on the set of motion vectors and second pose data associated with the second field image, and to the third field image based on the set of motion vectors and third pose data associated with the third field image. In an example, the pixel shading may be the pixel shading 616. In an example, the pixel shading may be the pixel shading performed by the core(s) 814 in FIG. 8. In an example, the second pose data may be or include the second display pose 818 and the third pose data may be or include the third display pose 822. In an example, 1106 may be performed by the reprojector 198.

In some aspects, the set of motion vectors may indicate a point-to-point mapping from a display space to a rendered eye buffer space. For example, the set of motion vectors may be associated with the mapping 812 and the set of motion vectors may indicate a point-to-point mapping from a display space to a rendered eye buffer space. In an example, the display space may be associated with the display 622 and the rendered eye buffer space may be associated with the eye buffer 716.

In some aspects, at 1108, the apparatus may transmit a first indication of the first field image, a second indication of the second field image, and a third indication of the third field image to a display processor for display of the first field image, the second field image, and the third field image, where the first indication of the first field image may be based on the application of the pixel shading to the first field image, the second indication of the second field image may be based on the application of the pixel shading to the second field image, and the third indication of the third field image may be based on the application of the pixel shading to the third field image. For example, FIG. 9 at 914 shows that the first display component 902 may transmit a first indication of the first field image, a second indication of the second field image, and a third indication of the third field image to a display processor for display of the first field image, the second field image, and the third field image, where the first indication of the first field image may be based on the application of the pixel shading to the first field image, the second indication of the second field image may be based on the application of the pixel shading to the second field image, and the third indication of the third field image may be based on the application of the pixel shading to the third field image. In an example, the display processor may be the display processor 127 or the DPU 406. In an example, 1108 may be performed by the reprojector 198.

In some aspects, at 1110, the apparatus may store a first indication of the first field image, a second indication of the second field image, and a third indication of the third field image in a first memory or a cache, where the first indication of the first field image may be based on the application of the pixel shading to the first field image, the second indication of the second field image may be based on the application of the pixel shading to the second field image, and the third indication of the third field image may be based on the application of the pixel shading to the third field image. For example, FIG. 9 at 912 shows that the first display component 902 may store a first indication of the first field image, a second indication of the second field image, and a third indication of the third field image in a first memory or a cache, where the first indication of the first field image may be based on the application of the pixel shading to the first field image, the second indication of the second field image may be based on the application of the pixel shading to the second field image, and the third indication of the third field image may be based on the application of the pixel shading to the third field image. In an example, 1110 may be performed by the reprojector 198.

In some aspects, the first pose data may include at least one of render pose data associated with the first field image or display pose data associated with the first field image. For example, the render pose data associated with the first field image may be the render pose 806 and the display pose data associated with the first field image may be the first display pose 808.

In some aspects, the second pose data may include display pose data associated with the second field image, and where the third pose data includes display pose data associated with the third field image. For example, the display pose data associated with the second field image may be the second display pose 818 and the display pose data associated with the third field image may be the third display pose 822.

In some aspects, at 1102, the apparatus may receive a depth buffer, where the depth buffer may include depth information indicative of a distance associated with an object represented by the set of field images, and where the depth buffer may be associated with the data representing the set of field images. For example, FIG. 9 at 906 shows that the first display component 902 may receive a depth buffer, where the depth buffer may include depth information indicative of a distance associated with an object represented by the set of field images, and where the depth buffer may be associated with the data representing the set of field images. In an example, the depth buffer may be or include the depth buffer 804. In an example, 1102 may be performed by the reprojector 198.

In some aspects, the data representing the set of field images may include planar metadata. For example, the data representing the set of field images received at 906 in FIG. 9 may include planar metadata.

In some aspects, the data representing the set of field images may include one or more motion vectors between consecutive eye buffer frames. For example, the data representing the set of field images received at 906 in FIG. 9 may include one or more motion vectors between consecutive eye buffer frames.

In some aspects, the apparatus may apply the pixel shading by applying a first homography-based correction to the set of motion vectors based on the second pose data associated with the second field image to obtain a first homography-based corrected set of motion vectors, applying a second homography-based correction to the set of motion vectors based on the third pose data associated with the third field image to obtain a second homography-based corrected set of motion vectors, and applying the pixel shading to the second field image based on the first homography-based corrected set of motion vectors and to the third field image based on the second homography-based corrected set of motion vectors. For example, the aforementioned aspect may correspond to the description of FIG. 7 and/or FIG. 8 above. In an example, the first homography-based correction and the second homography-based correction may be associated with the homography 702.

In some aspects, the first field image may correspond to a red image of an RGB image, the second field image may correspond to a green image of the RGB image, and the third field image may correspond to a blue image of the RGB image. For example, the first field image may be the first field 412, where the first field 412 may correspond to a red image of an RGB image. The second field image may be the second field 416, where the second field 416 may correspond to a green image of the RGB image. The third field image may be the third field 418, where the third field 418 may correspond to a blue image of the RGB image.

In configurations, a method or an apparatus for display processing is provided. The apparatus may be a DPU, a display processor, or some other processor that may perform display processing. The apparatus may be a graphics processor or a processing core. In aspects, the apparatus may be the display processor 127 within the device 104, or may be some other hardware within the device 104 or another device. In other aspects, the apparatus may be the processing unit 120. The apparatus may include means for determining a mapping including a set of motion vectors based on a single grid inversion to data representing a set of field images including a first field image, a second field image, and a third field image, where the single grid inversion is based on first pose data associated with the first field image. The apparatus may include means for applying pixel shading to the first field image based on the set of motion vectors, to the second field image based on the set of motion vectors and second pose data associated with the second field image, and to the third field image based on the set of motion vectors and third pose data associated with the third field image. The apparatus may include means for transmitting a first indication of the first field image, a second indication of the second field image, and a third indication of the third field image to a display processor for display of the first field image, the second field image, and the third field image, where the first indication of the first field image is based on the application of the pixel shading to the first field image, the second indication of the second field image is based on the application of the pixel shading to the second field image, and the third indication of the third field image is based on the application of the pixel shading to the third field image. The apparatus may include means for storing a first indication of the first field image, a second indication of the second field image, and a third indication of the third field image in a first memory or a cache, where the first indication of the first field image is based on the application of the pixel shading to the first field image, the second indication of the second field image is based on the application of the pixel shading to the second field image, and the third indication of the third field image is based on the application of the pixel shading to the third field image. The apparatus may include means for receiving a depth buffer, where the depth buffer includes depth information indicative of a distance associated with an object represented by the set of field images, and where the depth buffer is associated with the data representing the set of field images.

It is understood that the specific order or hierarchy of blocks in the processes / flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing comprising determining a mapping including a set of motion vectors based on a single grid inversion to data representing a set of field images including a first field image, a second field image, and a third field image, wherein the single grid inversion is based on first pose data associated with the first field image; and applying pixel shading to the first field image based on the set of motion vectors, to the second field image based on the set of motion vectors and second pose data associated with the second field image, and to the third field image based on the set of motion vectors and third pose data associated with the third field image.

Aspect 2 may be combined with aspect 1, wherein the set of motion vectors indicates a point-to-point mapping from a display space to a rendered eye buffer space.

Aspect 3 may be combined with any of aspects 1-2, further including: transmitting a first indication of the first field image, a second indication of the second field image, and a third indication of the third field image to a display processor for display of the first field image, the second field image, and the third field image, wherein the first indication of the first field image is based on the application of the pixel shading to the first field image, the second indication of the second field image is based on the application of the pixel shading to the second field image, and the third indication of the third field image is based on the application of the pixel shading to the third field image.

Aspect 4 may be combined with any of aspects 1-3, further including: storing a first indication of the first field image, a second indication of the second field image, and a third indication of the third field image in a first memory or a cache, wherein the first indication of the first field image is based on the application of the pixel shading to the first field image, the second indication of the second field image is based on the application of the pixel shading to the second field image, and the third indication of the third field image is based on the application of the pixel shading to the third field image.

Aspect 5 may be combined with any of aspects 1-4, wherein the first pose data includes at least one of: render pose data associated with the first field image; or display pose data associated with the first field image.

Aspect 6 may be combined with any of aspects 1-5, wherein the second pose data includes display pose data associated with the second field image, and wherein the third pose data includes display pose data associated with the third field image.

Aspect 7 may be combined with any of aspects 1-6, further including: receiving a depth buffer, wherein the depth buffer includes depth information indicative of a distance associated with an object represented by the set of field images, and wherein the depth buffer is associated with the data representing the set of field images.

Aspect 8 may be combined with any of aspects 1-7, wherein the data representing the set of field images includes planar metadata.

Aspect 9 may be combined with any of aspects 1-8, wherein the data representing the set of field images includes one or more motion vectors between consecutive eye buffer frames.

Aspect 10 may be combined with any of aspects 1-9, wherein applying the pixel shading includes: applying a first homography-based correction to the set of motion vectors based on the second pose data associated with the second field image to obtain a first homography-based corrected set of motion vectors; applying a second homography-based correction to the set of motion vectors based on the third pose data associated with the third field image to obtain a second homography-based corrected set of motion vectors; and applying the pixel shading to the second field image based on the first homography-based corrected set of motion vectors and to the third field image based on the second homography-based corrected set of motion vectors.

Aspect 11 may be combined with any of aspects 1-10, wherein the first field image corresponds to a red image of a red-green-blue (RGB) image, wherein the second field image corresponds to a green image of the RGB image, and the third field image corresponds to a blue image of the RGB image.

Aspect 12 is an apparatus for display processing including a memory and a processor coupled to the memory and, based on information stored in the memory, the processor is configured to implement a method as in any of aspects 1-11.

Aspect 13 may be combined with aspect 12 and includes that the apparatus is a wireless communication device comprising at least one of a transceiver or an antenna coupled to the processor.

Aspect 14 may be combined with any of aspects 12-13 and includes that the apparatus is a head-mounted display.

Aspect 15 is an apparatus for display processing including means for implementing a method as in any of aspects 1-11.

Aspect 16 is a computer-readable medium storing computer executable code, the computer executable code, when executed by a processor, causes the processor to implement a method as in any of aspects 1-11.

Various aspects have been described herein. These and other aspects are within the scope of the following claims.

What is claimed is:

1. An apparatus for display processing, comprising:
a memory; and
a processor coupled to the memory and, based on information stored in the memory, the processor is configured to:
determine a mapping comprising a set of motion vectors based on a single grid inversion to data representing a set of field images comprising a first field image, a second field image, and a third field image, wherein the single grid inversion is based on first pose data associated with the first field image; and
apply pixel shading to the first field image based on the set of motion vectors, to the second field image based on the set of motion vectors and second pose data associated with the second field image, and to the third field image based on the set of motion vectors and third pose data associated with the third field image.

2. The apparatus of claim 1, wherein the set of motion vectors indicates a point-to-point mapping from a display space to a rendered eye buffer space.

3. The apparatus of claim 1, wherein the processor is further configured to:
transmit a first indication of the first field image, a second indication of the second field image, and a third indication of the third field image to a display processor for display of the first field image, the second field image, and the third field image, wherein the first indication of the first field image is based on the application of the pixel shading to the first field image, the second indication of the second field image is based on the application of the pixel shading to the second field image, and the third indication of the third field image is based on the application of the pixel shading to the third field image.

4. The apparatus of claim 1, wherein the processor is further configured to:
store a first indication of the first field image, a second indication of the second field image, and a third indication of the third field image in a first memory or a cache, wherein the first indication of the first field image is based on the application of the pixel shading to the first field image, the second indication of the second field image is based on the application of the pixel shading to the second field image, and the third indication of the third field image is based on the application of the pixel shading to the third field image.

5. The apparatus of claim 1, wherein the first pose data comprises at least one of:
render pose data associated with the first field image; or
display pose data associated with the first field image.

6. The apparatus of claim 1, wherein the second pose data comprises second display pose data associated with the second field image, and wherein the third pose data comprises third display pose data associated with the third field image.

7. The apparatus of claim 1, wherein the processor is further configured to:
receive a depth buffer, wherein the depth buffer comprises depth information indicative of a distance associated with an object represented by the set of field images, and wherein the depth buffer is associated with the data representing the set of field images.

8. The apparatus of claim 1, wherein the data representing the set of field images comprises planar metadata.

9. The apparatus of claim 1, wherein the data representing the set of field images comprises one or more motion vectors between consecutive eye buffer frames.

10. The apparatus of claim 1, wherein to apply the pixel shading, the processor is configured to:
apply a first homography-based correction to the set of motion vectors based on the second pose data associated with the second field image to obtain a first homography-based corrected set of motion vectors;
apply a second homography-based correction to the set of motion vectors based on the third pose data associated with the third field image to obtain a second homography-based corrected set of motion vectors; and
apply the pixel shading to the second field image based on the first homography-based corrected set of motion vectors and to the third field image based on the second homography-based corrected set of motion vectors.

11. The apparatus of claim 1, wherein the first field image corresponds to a red image of a red-green-blue (RGB) image, wherein the second field image corresponds to a green image of the RGB image, and the third field image corresponds to a blue image of the RGB image.

12. The apparatus of claim 1, wherein the apparatus is a wireless communication device comprising at least one of a transceiver or an antenna coupled to the processor.

13. The apparatus of claim 1, wherein the apparatus is a head-mounted display.

14. A method of display processing, comprising:
determining a mapping comprising a set of motion vectors based on a single grid inversion to data representing a set of field images comprising a first field image, a second field image, and a third field image, wherein the single grid inversion is based on first pose data associated with the first field image; and
applying pixel shading to the first field image based on the set of motion vectors, to the second field image based on the set of motion vectors and second pose data associated with the second field image, and to the third field image based on the set of motion vectors and third pose data associated with the third field image.

15. The method of claim 14, wherein the set of motion vectors indicates a point-to-point mapping from a display space to a rendered eye buffer space.

16. The method of claim 14, further comprising:
transmitting a first indication of the first field image, a second indication of the second field image, and a third indication of the third field image to a display processor for display of the first field image, the second field image, and the third field image, wherein the first indication of the first field image is based on the application of the pixel shading to the first field image, the second indication of the second field image is based on the application of the pixel shading to the second field image, and the third indication of the third field image is based on the application of the pixel shading to the third field image.

17. The method of claim 14, further comprising:
storing a first indication of the first field image, a second indication of the second field image, and a third indication of the third field image in a first memory or a cache, wherein the first indication of the first field image is based on the application of the pixel shading to the first field image, the second indication of the second field image is based on the application of the pixel shading to the second field image, and the third indication of the third field image is based on the application of the pixel shading to the third field image.

18. The method of claim 14, wherein the first pose data comprises at least one of:
render pose data associated with the first field image; or
display pose data associated with the first field image.

19. The method of claim 14, wherein the second pose data comprises second display pose data associated with the second field image, and wherein the third pose data comprises third display pose data associated with the third field image.

20. A computer-readable medium storing computer executable code for display processing, the computer executable code, when executed by a processor, causes the processor to:
determine a mapping comprising a set of motion vectors based on a single grid inversion to data representing a set of field images comprising a first field image, a second field image, and a third field image, wherein the single grid inversion is based on first pose data associated with the first field image; and
apply pixel shading to the first field image based on the set of motion vectors, to the second field image based on the set of motion vectors and second pose data associated with the second field image, and to the third field image based on the set of motion vectors and third pose data associated with the third field image.
